(19) United States
(12) Patent Application Publication
(10) Pub. No.: US 2025/0246974 A1
(43) Pub. Date: Jul. 31, 2025

(54) ROTATING ELECTRIC MACHINE SYSTEM

(71) Applicant: HONDA MOTOR CO., LTD., Tokyo (JP)

(72) Inventors: Daijiro Eto, Wako-shi (JP); Yuki Wada, Wako-shi (JP)

(21) Appl. No.: 19/014,827

(22) Filed: Jan. 9, 2025

(30) Foreign Application Priority Data
Jan. 29, 2024 (JP) 2024-010665
Jan. 29, 2024 (JP) 2024-010666

(51) Int. Cl. H02K 9/193

(52) U.S. Cl. CPC H02K 9/193

(57) ABSTRACT

A rotating electric machine system is equipped with a rotating electric machine including a rotating electric machine body and a bearing portion, a supply pump configured to deliver oil in the liquid state, an oil flow path, and a heat exchanger, wherein the rotating electric machine is equipped with a rotor cooling flow path configured to allow the oil to flow through a rotor, a stator cooling flow path configured to allow the oil to flow through a stator, and a lubricant flow path, the oil cooled by the heat exchanger flows separately into the rotor cooling flow path and the stator cooling flow path, and the oil flowing through the stator cooling flow path is blown from the lubricant flow path to the bearing portion by the pressure of the supply pump.

### CROSS-REFERENCE TO RELATED APPLICATIONS

This application is based upon and claims the benefit of priority from Japanese Patent Applications No. 2024-010665 filed on Jan. 29, 2024, and No. 2024-010666 filed on Jan. 29, 2024, the contents of which are incorporated herein by reference.

### BACKGROUND OF THE INVENTION

### Field of the Invention

The present disclosure relates to a rotating electric machine system.

### Description of the Related Art

In recent years, research and development have been conducted on rotating electric machine system that contribute to energy efficiency in order to ensure that more people have access to affordable, reliable, sustainable and modern energy.

JP 2016-137790 A discloses a rotating electric machine system including a rotating electric machine body having a rotor and a stator, and a bearing portion rotatably supporting the rotor. In this rotating electric machine system, the rotor and the stator are cooled by causing liquid oil to flow through the rotor and the stator.

### SUMMARY OF THE INVENTION

There is a long-awaited need for a more suitable rotating electric machine system.

The present disclosure has the object of meeting the aforementioned need.

A first aspect of the present disclosure is characterized by a rotating electric machine system including a rotating electric machine including a rotating electric machine body provided with a rotor and a stator, and a bearing portion rotatably supporting the rotor, a supply pump configured to deliver oil in a liquid state, an oil flow path configured to guide the oil delivered from the supply pump, to the rotating electric machine, and a heat exchanger provided in the oil flow path and configured to cool the oil, wherein the rotating electric machine is equipped with a rotor cooling flow path configured to allow the oil to flow into the rotor, a stator cooling flow path configured to allow the oil to flow into the stator, and a lubricant flow path configured to supply the oil to the bearing portion, and wherein the oil that has been cooled by the heat exchanger flows separately into the rotor cooling flow path and the stator cooling flow path, and the oil flowing through the stator cooling flow path is blown from the lubricant flow path to the bearing portion by pressure of the supply pump.

A second aspect of the present disclosure is characterized by a rotating electric machine system including a rotating electric machine including a rotating electric machine body provided with a rotor and a stator, and a bearing portion rotatably supporting the rotor, a first oil flow path through which oil in a liquid state flows, a heat exchanger provided in the first oil flow path and configured to cool the oil, and a second oil flow path branching from a portion of the first oil flow path on an upstream side of the heat exchanger, wherein the oil that has been cooled by the heat exchanger is guided into the rotating electric machine body, and the oil flowing through the second oil flow path is guided to the bearing portion.

According to the present disclosure, a more satisfactory rotating electric machine system can be obtained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a rotating electric machine system according to a first embodiment of the present disclosure; and

FIG. 2 is a schematic diagram of a rotating electric machine system according to a second embodiment of the present disclosure.

### DETAILED DESCRIPTION OF THE INVENTION

In a rotating electric machine system, it is necessary to supply liquid oil to a bearing portion for lubrication purposes. However, the temperature of the oil suitable for lubricating the bearing portion is higher than the temperature of the oil suitable for cooling the rotating electric machine body.

Therefore, when oil at a temperature suitable for cooling the rotating electric machine body is supplied to the bearing portion, the frictional resistance of the bearing portion may increase due to the relatively high viscosity of the oil. On the other hand, when oil at a temperature suitable for lubricating the bearing portion is supplied to the rotating electric machine body, the rotating electric machine body may not be cooled efficiently.

The rotating electric machine is provided with a rotor cooling flow path for allowing oil to flow through the rotor, a stator cooling flow path for allowing oil through the stator, and a lubricant flow path for supplying oil to the bearing portion. The rotating electric machine system further includes a supply pump for supplying oil to the rotating electric machine. In such a rotating electric machine system, when the rotor cooling flow path, the stator cooling flow path, and the lubricant flow path are arranged in parallel, the required flow rate of oil for the rotating electric machine becomes relatively large, and therefore, the supply pump cannot be downsized. The first embodiment of the present disclosure is made in view of the above problems, and can provide the rotating electric machine system capable of efficiently cooling a rotating electric machine body while suppressing an increase in frictional resistance of the bearing portion, and further capable of reducing the size of a supply pump.

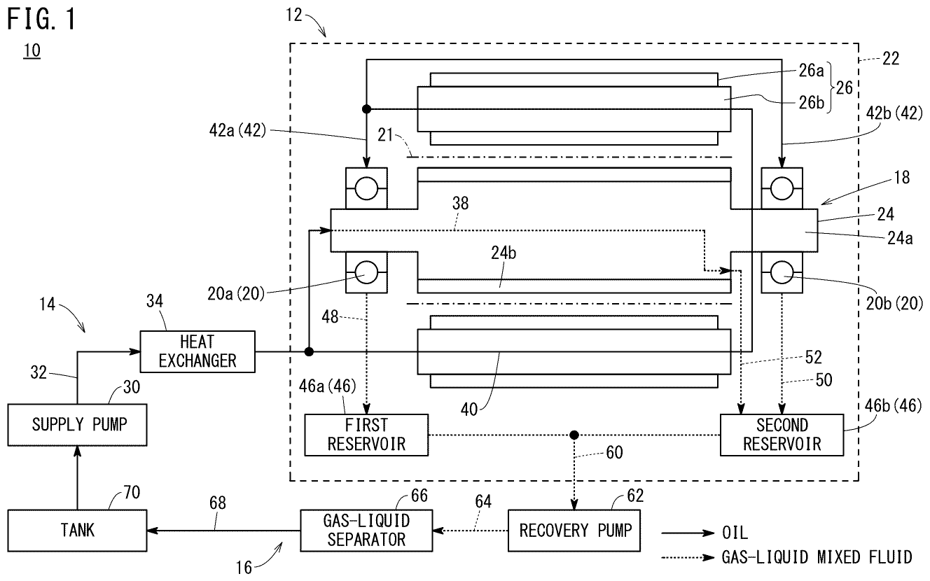

FIG. 1 is a schematic diagram of a rotating electric machine system 10 according to a first embodiment of the present disclosure. The rotating electric machine system 10 is mounted in an aircraft, for example. The aircraft may be, for example, an Electric Vertical Take-Off and Landing (eVTOL) aircraft. The aircraft is not limited to the electric vertical take-off and landing aircraft. The rotating electric machine system 10 is not limited to an example in which the rotating electric machine system is mounted in an aircraft, and may be mounted in a ship, a vehicle, or the like. The rotating electric machine system 10 may be provided in a stationary power generation device.

As shown in FIG. 1, the rotating electric machine system 10 includes a rotating electric machine 12, an oil supply device 14, and an oil recovery device 16. The rotating electric machine 12 includes a rotating electric machine body 18, bearing portions 20, a partition wall member 21, and a casing 22. The rotating electric machine body 18 includes a rotor 24 and a stator 26. The rotor 24 includes a rotating shaft 24a and a magnet member 24b provided on an outer circumferential portion of the rotating shaft 24a. The rotating shaft 24a is connected to, for example, a shaft portion of a gas turbine engine (not shown). The magnet member 24b is, for example, a permanent magnet. The stator 26 is formed in a cylindrical shape. The rotor 24 is inserted through a hole in the stator 26. The stator 26 includes a stator core 26a and an electromagnetic coil 26b. The rotor 24 and the stator 26 are not limited to the above-described configurations.

The rotating electric machine 12 functions as a motor for rotating the shaft portion of the gas turbine engine by supplying an alternating current to the electromagnetic coil 26b of the stator core 26a to rotate the rotor 24, when the gas turbine engine is started to be driven, for example. The rotating electric machine 12 functions as a generator that generates electricity by rotating the rotor 24 by the driving force of the gas turbine engine. In the rotating electric machine 12, the rotor 24 and the stator 26 generate heat. Specifically, in the rotating electric machine 12, each of the magnet member 24b of the rotor 24 and the electromagnetic coil 26b of the stator 26 is particularly likely to have a high temperature.

The bearing portions 20 have a first bearing 20a and a second bearing 20b. The first bearing 20a rotatably supports one end of the rotating shaft 24a. The second bearing 20b rotatably supports the other end of the rotating shaft 24a. Each of the first bearing 20a and the second bearing 20b is, for example, a rolling bearing. Each of the first bearing 20a and the second bearing 20b may be a slide bearing.

The partition wall member 21 is formed in a cylindrical shape. The rotor 24 is disposed inside the partition wall member 21, and the stator 26 is disposed outside the partition wall member 21. The partition wall member 21 is made of, for example, a ceramic material. The partition wall member 21 may be fixed to the casing 22. The partition wall member 21 liquid-tightly and airtightly isolates a space in which the rotor 24 is disposed from a space in which the stator 26 is disposed. The casing 22 accommodates the rotating electric machine body 18 and the bearing portions 20.

The oil supply device 14 supplies liquid oil to the rotating electric machine 12. Examples of the oil include gas turbine oil. The oil supply device 14 includes a supply pump 30, an oil flow path 32, and a heat exchanger 34.

The oil flow path 32 is connected to the supply pump 30. The oil supplied (discharged) from the supply pump 30 flows through the oil flow path 32. The heat exchanger 34 is provided in the oil flow path 32. The heat exchanger 34 cools the oil flowing through the oil flow path 32. A coolant for cooling the oil flows through the heat exchanger 34. As the coolant, for example, liquid water is used, but the present invention is not limited thereto. The coolant that has cooled the oil in the heat exchanger 34 returns to the heat exchanger 34 via, for example, a radiator and a cooling jacket (none of which is shown) formed on the casing 22. The coolant may cool the stator 26 by flowing through the cooling jacket. The radiator exchanges heat between the coolant and the outside air (cooling air). That is, the radiator cools the coolant with the cooling air. The oil cooled by the heat exchanger 34 is guided into the rotating electric machine body 18.

The rotating electric machine 12 is provided with a rotor cooling flow path 38, a stator cooling flow path 40, a lubricant flow path 42, reservoirs 46, a first discharge flow path 48, a second discharge flow path 50, and a third discharge flow path 52.

The oil guided from the oil flow path 32 is relatively low-temperature oil cooled by the heat exchanger 34. Specifically, the oil guided from the oil flow path 32 flows separately into the rotor cooling flow path 38 and the stator cooling flow path 40. That is, the rotor cooling flow path 38 and the stator cooling flow path 40 are arranged in parallel. The rotor cooling flow path 38 and the stator cooling flow path 40 are separated by the partition wall member 21. Therefore, the oil flowing through the rotor cooling flow path 38 and the oil flowing through the stator cooling flow path 40 do not mix with each other along the way.

The rotor cooling flow path 38 allows oil having a relatively low temperature to flow through the rotor 24. The rotor cooling flow path 38 includes a flow path formed within the rotor 24. In this case, the rotor 24 can be efficiently cooled by the oil flowing through the interior of the rotor 24. The rotor cooling flow path 38 is a flow path that is open to the atmosphere. Therefore, gas (air) is mixed with the oil flowing through the rotor cooling flow path 38. The stator cooling flow path 40 allows oil having a relatively low temperature to flow through the stator 26. The stator cooling flow path 40 is formed so as to surround the stator 26. In this case, since the oil can be brought into contact with the electromagnetic coil 26b of the stator 26, the stator 26 can be cooled efficiently. The stator cooling flow path 40 is a flow path that is not open to the atmosphere. Therefore, gas (air) is not mixed with the oil flowing through the stator cooling flow path 40.

The oil flowing through the stator cooling flow path 40 is heated by the heat of the stator 26. Therefore, the oil flowing through the stator cooling flow path 40 becomes relatively high temperature oil. The relatively high temperature oil flowing through the stator cooling flow path 40 is used for lubrication of the bearing portions 20. Specifically, the oil flowing through the stator cooling flow path 40 is guided to the lubricant flow path 42.

The lubricant flow path 42 includes a first lubricant flow path 42a and a second lubricant flow path 42b. The stator cooling flow path 40 and the lubricant flow path 42 are connected in series. The oil flowing through the stator cooling flow path 40 flows separately into the first lubricant flow path 42a and the second lubricant flow path 42b. The first lubricant flow path 42a supplies relatively high temperature oil to the first bearing 20a. The oil flowing through the first lubricant flow path 42a is blown to the first bearing 20a by the pressure of the supply pump 30. Gas (air) is mixed in the oil blown from the first lubricant flow path 42a to the first bearing 20a. The second lubricant flow path 42b supplies relatively high temperature oil to the second bearing 20b. The oil flowing through the second lubricant flow path 42b is blown to the second bearing 20b by the pressure of the supply pump 30. Gas (air) is mixed in the oil blown from the second lubricant flow path 42b to the second bearing 20b.

The reservoirs 46 are formed, for example, at the bottom portion of the casing 22. The reservoirs 46 include a first reservoir 46a and a second reservoir 46b. The first reservoir 46a is located, for example, below the first bearing 20a (in the direction of gravity). The second reservoir 46b is located, for example, below the second bearing 20b (in the direction of gravity). The size, shape, position, etc. of the reservoirs 46 can be set as appropriate.

The first discharge flow path 48 guides the oil flowing through the first bearing 20a to the first reservoir 46a. The second discharge flow path 50 guides the oil flowing through the second bearing 20b to the second reservoir 46b. The third discharge flow path 52 guides the oil flowing through the rotor cooling flow path 38 to the second reservoir 46b. Gas (air) is mixed in the oil flowing through the first discharge flow path 48, the second discharge flow path 50, and the third discharge flow path 52. That is, the reservoirs 46 store a gas-liquid mixed fluid in which a liquid oil and a gaseous air are mixed.

The oil recovery device 16 includes a recovery flow path 60, a recovery pump 62, a lead-out flow path 64, a gas-liquid separator 66, a circulation flow path 68, and a tank 70. The recovery flow path 60 is connected to the first reservoir 46a, the second reservoir 46b, and the recovery pump 62. The lead-out flow path 64 connects the recovery pump 62 and the gas-liquid separator 66. The recovery pump 62 delivers the gas-liquid mixed fluid stored in the first reservoir 46a and the second reservoir 46b to the gas-liquid separator 66. The gas-liquid separator 66 separates gas from the gas-liquid mixed fluid guided from the reservoirs 46. The circulation flow path 68 is a flow path for returning the oil from which the gas has been removed by the gas-liquid separator 66 to the supply pump 30. The tank 70 is provided in the circulation flow path 68. The tank 70 stores liquid oil.

Next, the flow of oil in the rotating electric machine system 10 will be described. When the supply pump 30 is driven, the liquid oil stored in the tank 70 is sent to the oil flow path 32 through the supply pump 30. The oil flowing through the oil flow path 32 is cooled by the heat exchanger 34, and thus becomes relatively low temperature oil.

The relatively low temperature oil flowing through the heat exchanger 34 flows separately into the rotor cooling flow path 38 and the stator cooling flow path 40. The oil flowing through the rotor cooling flow path 38 is guided to the second reservoir 46b through the third discharge flow path 52 by the gravity and the centrifugal force generated by the rotation of the rotor 24 after the rotor 24 is cooled. Gas (air) is mixed in the oil flowing through the third discharge flow path 52. That is, the oil flowing through the third discharge flow path 52 is a gas-liquid mixed fluid.

The rotor cooling flow path 38 is open to the atmosphere. Therefore, the pressure of the oil flowing through the rotor cooling flow path 38 is lower than the pressure of the supply pump 30. That is, the oil flowing through the rotor cooling flow path 38 has a relatively low pressure. Therefore, in the present embodiment, the oil flowing through the rotor cooling flow path 38 is not used for lubrication of the bearing portions 20.

The oil flowing through the stator cooling flow path 40 flows separately into the first lubricant flow path 42a and the second lubricant flow path 42b after cooling the stator 26. The oil flowing through the stator cooling flow path 40 is heated by the heat of the stator 26, and thus becomes relatively high temperature oil. In other words, the oil flowing through the stator cooling flow path 40 has a temperature suitable for lubricating the bearing portions 20. The stator cooling flow path 40 is not open to the atmosphere. In other words, gas (air) is not mixed with the oil flowing through the stator cooling flow path 40. That is, the pressure of the oil flowing through the stator cooling flow path 40 is equal to the pressure of the supply pump 30. The oil flowing through the stator cooling flow path 40 is used for lubrication of the bearing portions 20 because a high pressure is maintained.

The oil flowing through the first lubricant flow path 42a is blown to the first bearing 20a by the pressure of the supply pump 30. As a result, the first bearing 20a is lubricated by the oil. The oil flowing through the first bearing 20a flows down to the first reservoir 46a through the first discharge flow path 48 by gravity. Gas (air) is mixed with the oil flowing through the first discharge flow path 48. That is, the oil flowing through the first discharge flow path 48 is a gas-liquid mixed fluid.

The oil flowing through the second lubricant flow path 42b is blown to the second bearing 20b by the pressure of the supply pump 30. As a result, the second bearing 20b is lubricated by the oil. The oil flowing through the second bearing 20b flows down to the second reservoir 46b through the second discharge flow path 50 by gravity. Gas (air) is mixed with the oil flowing through the second discharge flow path 50. That is, the oil flowing through the second discharge flow path 50 is a gas-liquid mixed fluid.

The gas-liquid mixed fluid stored in the first reservoir 46a and the second reservoir 46b is sent to the gas-liquid separator 66 by the recovery pump 62 through the recovery flow path 60 and the lead-out flow path 64. The gas-liquid mixed fluid sent to the gas-liquid separator 66 is separated into oil and gas (air) by the gas-liquid separator 66. The oil, from which the gas is separated by the gas-liquid separator 66, is guided into the tank 70.

According to the present embodiment, the relatively low temperature oil cooled by the heat exchanger 34 flows separately into the rotor cooling flow path 38 and the stator cooling flow path 40, so that the rotor 24 and the stator 26 can be cooled efficiently. The oil flowing through the stator cooling flow path 40 becomes relatively high temperature oil heated by the heat of the stator 26. Since the relatively high temperature oil flowing through the stator cooling flow path 40 is blown to the bearing portions 20 by the pressure of the supply pump 30, an increase in the frictional resistance of the bearing portions 20 can be suppressed. Thus, the rotating electric machine body 18 can be efficiently cooled while suppressing an increase in frictional resistance of the bearing portions 20.

Since the oil flowing through the stator cooling flow path 40 is used for lubrication of the bearing portions 20, the required flow rate of the oil to the rotating electric machine 12 can be reduced as compared with the case where the rotor cooling flow path 38, the stator cooling flow path 40, and the lubricant flow path 42 are arranged in parallel.

Specifically, for example, the flow rate of oil required for cooling the rotor 24 is referred to as a first flow rate L1, the flow rate of oil required for cooling the stator 26 is referred to as a second flow rate L2, and the flow rate of oil required for lubricating the bearing portions 20 is referred to as a third flow rate L3. It is assumed that the first flow rate L1 is larger than the third flow rate L3. When the rotor cooling flow path 38, the stator cooling flow path 40, and the lubricant flow path 42 are arranged in parallel, the supply pump 30 needs to supply the rotating electric machine 12 with oil at a flow rate obtained by adding up the first flow rate L1, the second flow rate L2, and the third flow rate L3. In the present embodiment, since the oil flowing through the stator cooling flow path 40 is blown to the bearing portions 20 from the lubricant flow path 42, the supply pump 30 only needs to supply the oil of the flow rate obtained by adding up the first flow rate L1 and the second flow rate L2 to the rotating electric machine 12. That is, in this example, the flow rate of the oil that needs to be supplied to the rotating electric machine 12 by the supply pump 30 can be reduced by the amount of the third flow rate L3. This allows the supply pump 30 to be made smaller. Accordingly, a more satisfactory rotating electric machine system 10 can be obtained.

As described above, in the rotating electric machine system, it is necessary to supply liquid oil to the bearing portions for the purpose of lubrication. However, the temperature of the oil suitable for lubricating the bearing portions is higher than the temperature of the oil suitable for cooling the rotating electric machine body.

Therefore, when oil at a temperature suitable for cooling the rotating electric machine body is supplied to the bearing portions, the frictional resistance of the bearing portions may increase due to the relatively high viscosity of the oil. On the other hand, when oil at a temperature suitable for lubricating the bearing portions is supplied to the rotating electric machine body, the rotating electric machine body may not be cooled efficiently. The second embodiment of the present disclosure can provide a rotating electric machine system capable of efficiently cooling a rotating electric machine body while suppressing an increase in frictional resistance of the bearing portions.

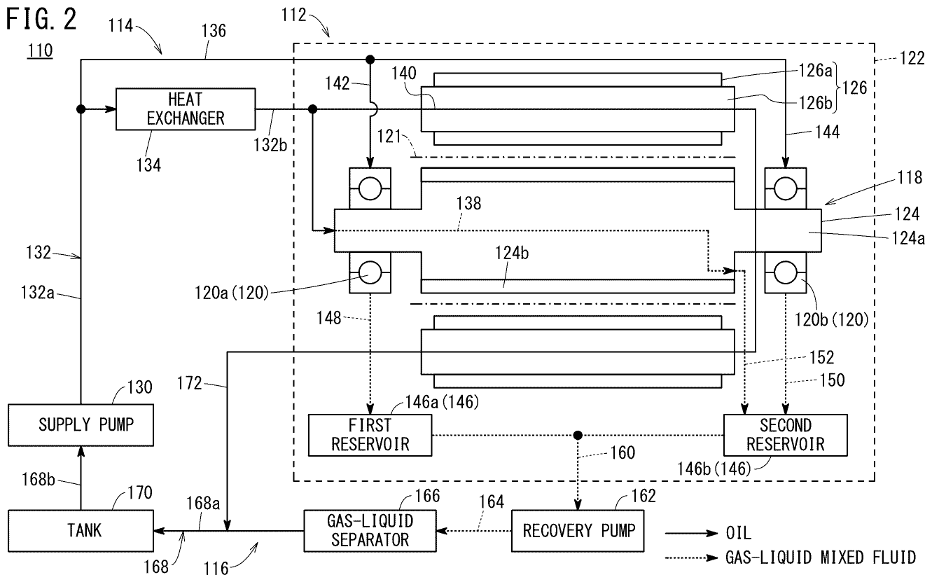

FIG. 2 is a schematic diagram of a rotating electric machine system 110 according to a second embodiment of the present disclosure. The rotating electric machine system 110 is mounted in an aircraft, for example. The aircraft may be, for example, an Electric Vertical Take-Off and Landing (eVTOL) aircraft. The aircraft is not limited to the electric vertical take-off and landing aircraft. The rotating electric machine system 110 is not limited to an example in which the rotating electric machine system is mounted in an aircraft, and may be mounted in a ship, a vehicle, or the like. The rotating electric machine system 110 may be provided in a stationary power generation device.

As shown in FIG. 2, the rotating electric machine system 110 includes a rotating electric machine 112, an oil supply device 114, and an oil recovery device 116. The rotating electric machine 112 includes a rotating electric machine body 118, bearing portions 120, a partition wall member 121, and a casing 122. The rotating electric machine body 118 includes a rotor 124 and a stator 126. The rotor 124 includes a rotating shaft 124a and a magnet member 124b provided on an outer circumferential portion of the rotating shaft 124a. The rotating shaft 124a is connected to, for example, a shaft portion of a gas turbine engine (not shown). The magnet member 124b is, for example, a permanent magnet. The stator 126 is formed in a cylindrical shape. The rotor 124 is inserted through a hole in the stator 126. The stator 126 includes a stator core 126a and an electromagnetic coil 126b. The rotor 124 and the stator 126 are not limited to the above-described configurations.

The rotating electric machine 112 functions as a motor for rotating the shaft portion of the gas turbine engine by supplying an alternating current to the electromagnetic coil 126b of the stator core 126a to rotate the rotor 124, when the gas turbine engine is started to be driven, for example. The rotating electric machine 112 functions as a generator that generates electricity by rotating the rotor 124 by the driving force of the gas turbine engine. In the rotating electric machine 112, the rotor 124 and the stator 126 generate heat. Specifically, in the rotating electric machine 112, each of the magnet member 124b of the rotor 124 and the electromagnetic coil 126b of the stator 126 is particularly likely to have a high temperature.

The bearing portions 120 have a first bearing 120a and a second bearing 120b. The first bearing 120a rotatably supports one end of the rotating shaft 124a. The second bearing 120b rotatably supports the other end of the rotating shaft 124a. Each of the first bearing 120a and the second bearing 120b is, for example, a rolling bearing. Each of the first bearing 120a and the second bearing 120b may be a slide bearing. The casing 122 accommodates the rotating electric machine body 118 and the bearing portions 120.

The partition wall member 121 is formed in a cylindrical shape. The rotor 124 is disposed inside the partition wall member 121, and the stator 126 is disposed outside the partition wall member 121. The partition wall member 121 is made of, for example, a ceramic material. The partition wall member 121 may be fixed to the casing 122. The partition wall member 121 liquid-tightly and airtightly isolates a space in which the rotor 124 is disposed from a space in which the stator 126 is disposed.

The oil supply device 114 supplies liquid oil to the rotating electric machine 112. Examples of the oil include gas turbine oil. The oil supply device 114 includes a supply pump 130, a first oil flow path 132, a heat exchanger 134, and a second oil flow path 136.

The first oil flow path 132 is connected to the supply pump 130. The oil supplied (discharged) from the supply pump 130 flows through the first oil flow path 132. The heat exchanger 134 is provided in the first oil flow path 132. The heat exchanger 134 cools the oil flowing through the first oil flow path 132. A coolant for cooling the oil flows through the heat exchanger 134. As the coolant, for example, liquid water is used, but the present invention is not limited thereto. The coolant that has cooled the oil in the heat exchanger 134 returns to the heat exchanger 134 via, for example, a radiator and a cooling jacket (none of which is shown) formed on the casing 122. The coolant may cool the stator 126 by flowing through the cooling jacket. The radiator exchanges heat between the coolant and the outside air (cooling air). That is, the radiator cools the coolant with the cooling air.

The first oil flow path 132 includes a supply flow path 132a and an introduction flow path 132b. The supply flow path 132a connects the supply pump 130 and the heat exchanger 134. In other words, the supply flow path 132a forms a portion of the first oil flow path 132 on the upstream side of the heat exchanger 134. The introduction flow path 132b connects the heat exchanger 134 and the rotating electric machine 112. The oil cooled by the heat exchanger 134 is guided into the rotating electric machine body 118.

The second oil flow path 136 branches from the supply flow path 132a. The second oil flow path 136 guides the oil flowing through the supply flow path 132a to the rotating electric machine 112. In other words, the second oil flow path 136 guides the oil before being cooled by the heat exchanger 134 to the rotating electric machine 112. The second oil flow path 136 connects the supply flow path 132a and the rotating electric machine 112.

The rotating electric machine 112 is provided with a rotor cooling flow path 138, a stator cooling flow path 140, a first lubricant flow path 142, a second lubricant flow path 144, reservoirs 146, a first discharge flow path 148, a second discharge flow path 150, and a third discharge flow path 152.

The oil guided from the introduction flow path 132b of the first oil flow path 132 is relatively low-temperature oil cooled by the heat exchanger 134, and is therefore used for cooling the rotating electric machine body 118. Specifically, the oil guided from the introduction flow path 132b flows separately into the rotor cooling flow path 138 and the stator cooling flow path 140. That is, the rotor cooling flow path 138 and the stator cooling flow path 140 are arranged in parallel. The rotor cooling flow path 138 and the stator cooling flow path 140 are separated by the partition wall member 121. Therefore, the oil flowing through the rotor cooling flow path 138 and the oil flowing through the stator cooling flow path 140 do not mix with each other along the way.

The rotor cooling flow path 138 allows oil having a relatively low temperature to flow through the rotor 124. The rotor cooling flow path 138 includes a flow path formed within the rotor 124. In this case, the rotor 124 can be efficiently cooled by the oil flowing through the interior of the rotor 124. The rotor cooling flow path 138 is a flow path that is open to the atmosphere. Therefore, gas (air) is mixed with the oil flowing through the rotor cooling flow path 138. The stator cooling flow path 140 allows oil having a relatively low temperature to flow through the stator 126. The stator cooling flow path 140 is formed so as to surround the stator 126. In this case, since the oil can be brought into contact with the electromagnetic coil 126b of the stator 126, the stator 126 can be cooled efficiently. The stator cooling flow path 140 is a flow path that is not open to the atmosphere. Therefore, gas (air) is not mixed with the oil flowing through the stator cooling flow path 140.

The oil guided from the second oil flow path 136 is relatively high-temperature oil that has not passed through the heat exchanger 134, and is therefore used for lubrication of the bearing portions 120. Specifically, the oil guided from the second oil flow path 136 flows separately into the first lubricant flow path 142 and the second lubricant flow path 144. The first lubricant flow path 142 supplies relatively high temperature oil to the first bearing 120a. The oil flowing through the first lubricant flow path 142 is blown to the first bearing 120a by the pressure of the supply pump 130. Gas (air) is mixed in the oil blown from the first lubricant flow path 142 to the first bearing 120a. The second lubricant flow path 144 supplies relatively high temperature oil to the second bearing 120b. The oil flowing through the second lubricant flow path 144 is blown to the second bearing 120b by the pressure of the supply pump 130. Gas (air) is mixed in the oil blown from the second lubricant flow path 144 to the second bearing 120b.

The reservoirs 146 are formed, for example, at the bottom portion of the casing 122. The reservoirs 146 include a first reservoir 146a and a second reservoir 146b. The first reservoir 146a is located, for example, below the first bearing 120a (in the direction of gravity). The second reservoir 146b is located, for example, below the second bearing 120b (in the direction of gravity). The size, shape, position, etc. of the reservoirs 146 can be set as appropriate.

The first discharge flow path 148 guides the oil flowing through the first bearing 120a to the first reservoir 146a. The second discharge flow path 150 guides the oil flowing through the second bearing 120b to the second reservoir 146b. The third discharge flow path 152 guides the oil flowing through the rotor cooling flow path 138 to the second reservoir 146b. Gas (air) is mixed in the oil flowing through the first discharge flow path 148, the second discharge flow path 150, and the third discharge flow path 152. That is, the reservoirs 146 store a gas-liquid mixed fluid in which a liquid oil and a gaseous air are mixed.

The oil recovery device 116 has a recovery flow path 160, a recovery pump 162, a lead-out flow path 164, a gas-liquid separator 166, a circulation flow path 168, a tank 170, and a bypass flow path 172. The recovery flow path 160 is connected to the first reservoir 146a, the second reservoir 146b, and the recovery pump 162. The lead-out flow path 164 connects the recovery pump 162 and the gas-liquid separator 166. The recovery pump 162 delivers the gas-liquid mixed fluid stored in the first reservoir 146a and the second reservoir 146b to the gas-liquid separator 166. The gas-liquid separator 166 separates gas from the gas-liquid mixed fluid guided from the reservoirs 146. The circulation flow path 168 is a flow path for returning the oil from which the gas has been removed by the gas-liquid separator 166 to the supply pump 130.

The tank 170 is provided in the circulation flow path 168. The circulation flow path 168 includes a first flow path portion 168a connecting the gas-liquid separator 166 and the tank 170, and a second flow path portion 168b connecting the tank 170 and the supply pump 130. The tank 170 stores liquid oil. The bypass flow path 172 connects the stator cooling flow path 140 and the first flow path portion 168a with each other. The bypass flow path 172 returns the oil flowing through the stator cooling flow path 140 to the circulation flow path 168 without passing the oil through the recovery pump 162 and the gas-liquid separator 166.

Next, the flow of oil in the rotating electric machine system 110 will be described. When the supply pump 130 is driven, the liquid oil stored in the tank 170 is sent to the supply flow path 132a of the first oil flow path 132 via the supply pump 130. The oil flowing through the supply flow path 132a flows separately into the heat exchanger 134 and the second oil flow path 136. The oil flowing through the heat exchanger 134 is cooled by the heat exchanger 134, and thus becomes relatively low temperature oil. The oil flowing through the second oil flow path 136 does not flow through the heat exchanger 134, and thus becomes relatively high temperature oil.

The relatively low temperature oil flowing through the heat exchanger 134 flows separately into the rotor cooling flow path 138 and the stator cooling flow path 140, via the introduction flow path 132b. The oil flowing through the rotor cooling flow path 138 is guided to the second reservoir 146b through the third discharge flow path 152 by the gravity and the centrifugal force generated by the rotation of the rotor 124 after the rotor 124 is cooled. Gas (air) is mixed with the oil flowing through the third discharge flow path 152. That is, the oil flowing through the third discharge flow path 152 is a gas-liquid mixed fluid.

The oil flowing through the stator cooling flow path 140 is guided to the tank 170 through the bypass flow path 172 and the first flow path portion 168a after cooling the stator 126. No gas is mixed in the oil flowing through the stator cooling flow path 140. Therefore, the oil can be circulated through the supply flow path 132a, the heat exchanger 134, the introduction flow path 132b, the stator cooling flow path 140, the bypass flow path 172, the first flow path portion 168a, the tank 170, and the second flow path portion 168b, by the pressure of the supply pump 130.

The relatively high temperature oil flowing through the second oil flow path 136 flows separately into the first lubricant flow path 142 and the second lubricant flow path 144. The oil flowing through the first lubricant flow path 142 is blown onto the first bearing 120a. As a result, the first bearing 120a is lubricated by the oil. The oil flowing through the first bearing 120a flows down to the first reservoir 146a through the first discharge flow path 148 by gravity. Gas (air) is mixed with the oil flowing through the first discharge flow path 148. That is, the oil flowing through the first discharge flow path 148 is a gas-liquid mixed fluid.

The oil flowing through the second lubricant flow path 144 is blown onto the second bearing 120b. As a result, the second bearing 120b is lubricated by the oil. The oil flowing through the second bearing 120b flows down to the second reservoir 146b through the second discharge flow path 150 by gravity. Gas (air) is mixed with the oil flowing through the second discharge flow path 150. That is, the oil flowing through the second discharge flow path 150 is a gas-liquid mixed fluid.

The gas-liquid mixed fluid stored in the first reservoir 146a and the second reservoir 146b is sent to the gas-liquid separator 166 by the recovery pump 162 through the recovery flow path 160 and the lead-out flow path 164. The gas-liquid mixed fluid sent to the gas-liquid separator 166 is separated into oil and gas (air) by the gas-liquid separator 166. The oil, from which the gas is separated by the gas-liquid separator 166, is guided into the tank 170 through the first flow path portion 168a.

According to the present embodiment, the relatively low temperature oil cooled by the heat exchanger 134 is guided to the rotating electric machine body 118, so that the rotating electric machine body 118 can be cooled efficiently. The oil flowing through the second oil flow path 136 does not pass through the heat exchanger 134, and thus becomes relatively high temperature oil. Since the relatively high temperature oil flowing through the second oil flow path 136 is guided to the bearing portions 120, an increase in the frictional resistance of the bearing portions 120 can be suppressed. Thus, the rotating electric machine body 118 can be efficiently cooled while suppressing an increase in frictional resistance of the bearing portions 120. Accordingly, a more satisfactory rotating electric machine system 110 can be obtained.

The present embodiment is not limited to the configuration described above. The rotating electric machine system 110 may cool only either the rotor 124 or the stator 126. The rotating electric machine system 110 may be configured to guide the oil flowing through the stator cooling flow path 140 to the reservoirs 146 without providing the bypass flow path 172.

The following supplementary notes are further disclosed in relation to the above-described embodiments.

### Supplementary Note 1

The rotating electric machine system (10) according to the present disclosure includes the rotating electric machine (12) including the rotating electric machine body (18) provided with the rotor (24) and the stator (26), and the bearing portion (20) rotatably supporting the rotor, the supply pump (30) configured to deliver oil in the liquid state, the oil flow path (32) configured to guide the oil delivered from the supply pump, to the rotating electric machine, and the heat exchanger (34) provided in the oil flow path and configured to cool the oil, wherein the rotating electric machine is equipped with the rotor cooling flow path (38) configured to allow the oil to flow into the rotor, the stator cooling flow path (40) configured to allow the oil to flow into the stator, and the lubricant flow path (42) configured to supply the oil to the bearing portion, and wherein the oil that has been cooled by the heat exchanger flows separately into the rotor cooling flow path and the stator cooling flow path, and the oil flowing through the stator cooling flow path is blown from the lubricant flow path to the bearing portion by pressure of the supply pump.

In accordance with such a configuration, the relatively low temperature oil cooled by the heat exchanger flows separately into the rotor cooling flow path and the stator cooling flow path, so that the rotor and the stator can be cooled efficiently. The oil flowing through the stator cooling flow path becomes relatively high temperature oil heated by the heat of the stator. Since the relatively high temperature oil flowing through the stator cooling flow path is blown to the bearing portion by the pressure of the supply pump, an increase in the frictional resistance of the bearing portion can be suppressed. Thus, the rotating electric machine body can be efficiently cooled while suppressing an increase in frictional resistance of the bearing portion. Since the oil flowing through the stator cooling flow path is used for lubrication of the bearing portion, the required flow rate of the oil to the rotating electric machine can be reduced as compared with the case where the rotor cooling flow path, the stator cooling flow path, and the lubricant flow path are arranged in parallel. This allows the supply pump to be made smaller. Accordingly, a more satisfactory rotating electric machine system can be obtained.

### Supplementary Note 2

In the rotating electric machine system according to the supplementary note 1, the rotor cooling flow path may be the flow path open to the atmosphere.

In accordance with such a configuration, the rotor cooling flow path can be easily provided in the rotating electric machine body.

### Supplementary Note 3

In the rotating electric machine system according to the supplementary note 1, the stator cooling flow path may be the flow path not open to the atmosphere.

In accordance with such a configuration, it is possible to suppress a decrease in the pressure of the oil when the oil flows through the stator cooling flow path.

### Supplementary Note 4

The rotating electric machine system according to the supplementary note 2 may further include the reservoir (46) configured to store the oil flowing through the rotor cooling flow path and being mixed with the gas, and the oil flowing through the bearing portion and being mixed with the gas, the recovery flow path (60) configured to recover the oil stored in the reservoir, the gas-liquid separator (66) configured to separate the gas from the oil guided through the recovery flow path, and the circulation flow path (68) configured to guide the oil, from which the gas has been separated by the gas-liquid separator, to the supply pump.

In accordance with such a configuration, the oil used for cooling the rotating electric machine body and the oil used for lubricating the bearing portion can be returned to the supply pump and reused. Further, since the gas is separated by the gas-liquid separator, it is possible to suppress a decrease in cooling efficiency and a decrease in lubrication efficiency, due to the mixing of the gas with the oil.

### Supplementary Note 5

The rotating electric machine system according to the supplementary note 4 may further include the recovery pump (62) configured to guide the oil stored in the reservoir to the gas-liquid separator.

In accordance with such a configuration, the oil stored in the reservoir can be reliably delivered to the gas-liquid separator by the recovery pump.

### Supplementary Note 6

The rotating electric machine system (110) according to the present disclosure includes the rotating electric machine (112) including the rotating electric machine body (118) provided with the rotor (124) and the stator (126), and the bearing portion (120) rotatably supporting the rotor, the first oil flow path (132) through which the oil in the liquid state flows, the heat exchanger (134) provided in the first oil flow path and configured to cool the oil, and the second oil flow path (136) branching from the portion of the first oil flow path on the upstream side of the heat exchanger, wherein the oil that has been cooled by the heat exchanger is guided into the rotating electric machine body, and the oil flowing through the second oil flow path is guided to the bearing portion.

In accordance with such a configuration, the relatively low temperature oil cooled by the heat exchanger is guided to the rotating electric machine body, so that the rotating electric machine body can be cooled efficiently. The oil flowing through the second oil flow path does not pass through the heat exchanger, and thus becomes relatively high temperature oil. Since the relatively high temperature oil flowing through the second oil flow path is guided to the bearing portion, an increase in the frictional resistance of the bearing portion can be suppressed. Thus, the rotating electric machine body can be efficiently cooled while suppressing an increase in frictional resistance of the bearing portion. Accordingly, a more satisfactory rotating electric machine system can be obtained.

### Supplementary Note 7

In the rotating electric machine system according to supplementary note 6, the rotating electric machine may include the rotor cooling flow path (138) configured to allow the oil to flow into the rotor, the stator cooling flow path (140) configured to allow the oil to flow into the stator, wherein the oil that has been cooled by the heat exchanger may flow separately into the rotor cooling flow path and the stator cooling flow path.

In accordance with such a configuration, the rotor and the stator can be efficiently cooled by the oil.

### Supplementary Note 8

The rotating electric machine system according to supplementary note 7 may further include the supply pump (130) configured to supply the oil to the first oil flow path, wherein the first oil flow path may include the supply flow path (132a) connecting the supply pump and the heat exchanger, and the second oil flow path may be connected to the supply flow path.

In accordance with such a configuration, the oil can be delivered separately to the heat exchanger and the second oil flow path by the supply pump.

### Supplementary Note 9

The rotating electric machine system according to supplementary note 8 may further include the reservoir (146) configured to store the oil flowing through the rotor cooling flow path and being mixed with a gas, and the oil flowing through the bearing portion and being mixed with the gas, the recovery flow path (160) configured to recover the oil stored in the reservoir, the gas-liquid separator (166) configured to separate the gas from the oil guided through the recovery flow path, and the circulation flow path (168) configured to guide the oil, from which the gas has been separated by the gas-liquid separator, to the supply pump.

In accordance with such a configuration, the oil flowing through the rotor cooling flow path and the oil flowing through the bearing portion can be returned to the supply pump and reused. Further, since the gas is separated by the gas-liquid separator, it is possible to suppress a decrease in cooling efficiency and a decrease in lubrication efficiency, due to the mixing of the gas with the oil.

### Supplementary Note 10

The rotating electric machine system according to the supplementary note 9 may further include the recovery pump (162) configured to guide the oil stored in the reservoir to the gas-liquid separator.

In accordance with such a configuration, the oil stored in the reservoir can be reliably delivered to the gas-liquid separator by the recovery pump.

### Supplementary Note 11

The rotating electric machine system according to the supplementary note 10 may further include the bypass flow path (172) configured to return the oil flowing through the stator cooling flow path to the circulation flow path without passing the oil through the recovery pump and the gas-liquid separator.

In accordance with such a configuration, the oil, which flows in the stator cooling flow path and is not mixed with the gas, can be returned to the supply pump and reused. The oil that has flowed through the stator cooling flow path does not flow through the recovery pump and the gas-liquid separator. Therefore, the amount of oil flowing through the recovery pump and the gas-liquid separator when a predetermined amount of oil is circulated once can be reduced, as compared with the case where the oil that has flowed through the stator cooling flow path is configured to flow through the recovery pump and the gas-liquid separator. Accordingly, since it is possible to reduce the loads on the recovery pump and the gas-liquid separator, the sizes of the recovery pump and the gas-liquid separator can be respectively reduced.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of each of the operations and the order of each of the processes are shown as examples, and the present invention is not limited to such operations and processes. The same applies to the case where numerical values or mathematical expressions are used in the description of the above-described embodiments.

1. A rotating electric machine system comprising:
a rotating electric machine including a rotating electric machine body provided with a rotor and a stator, and a bearing portion rotatably supporting the rotor;
a supply pump configured to deliver oil in a liquid state;
an oil flow path configured to guide the oil delivered from the supply pump, to the rotating electric machine; and
a heat exchanger provided in the oil flow path and configured to cool the oil,
wherein the rotating electric machine is equipped with:
a rotor cooling flow path configured to allow the oil to flow into the rotor;
a stator cooling flow path configured to allow the oil to flow into the stator; and
a lubricant flow path configured to supply the oil to the bearing portion, and
wherein the oil that has been cooled by the heat exchanger flows separately into the rotor cooling flow path and the stator cooling flow path, and
the oil flowing through the stator cooling flow path is blown from the lubricant flow path to the bearing portion by pressure of the supply pump.

2. The rotating electric machine system according to claim 1, wherein the rotor cooling flow path is a flow path open to atmosphere.

3. The rotating electric machine system according to claim 1, wherein the stator cooling flow path is a flow path not open to atmosphere.

4. The rotating electric machine system according to claim 2, further comprising:
a reservoir configured to store the oil flowing through the rotor cooling flow path and being mixed with a gas, and the oil flowing through the bearing portion and being mixed with the gas;
a recovery flow path configured to recover the oil stored in the reservoir;
a gas-liquid separator configured to separate the gas from the oil guided through the recovery flow path; and
a circulation flow path configured to guide the oil, from which the gas has been separated by the gas-liquid separator, to the supply pump.

5. The rotating electric machine system according to claim 4, further comprising a recovery pump configured to guide the oil stored in the reservoir to the gas-liquid separator.

6. A rotating electric machine system comprising:
a rotating electric machine including a rotating electric machine body provided with a rotor and a stator, and a bearing portion rotatably supporting the rotor;
a first oil flow path through which oil in a liquid state flows;
a heat exchanger provided in the first oil flow path and configured to cool the oil; and
a second oil flow path branching from a portion of the first oil flow path on an upstream side of the heat exchanger,
wherein the oil that has been cooled by the heat exchanger is guided into the rotating electric machine body, and
the oil flowing through the second oil flow path is guided to the bearing portion.

7. The rotating electric machine system according to claim 6, wherein the rotating electric machine includes:
a rotor cooling flow path configured to allow the oil to flow into the rotor;
a stator cooling flow path configured to allow the oil to flow into the stator, and
wherein the oil that has been cooled by the heat exchanger flows separately into the rotor cooling flow path and the stator cooling flow path.

8. The rotating electric machine system according to claim 7, further comprising a supply pump configured to supply the oil to the first oil flow path,
wherein the first oil flow path includes a supply flow path connecting the supply pump and the heat exchanger, and
the second oil flow path is connected to the supply flow path.

9. The rotating electric machine system according to claim 8, further comprising:
a reservoir configured to store the oil flowing through the rotor cooling flow path and being mixed with a gas, and the oil flowing through the bearing portion and being mixed with the gas;
a recovery flow path configured to recover the oil stored in the reservoir;
a gas-liquid separator configured to separate the gas from the oil guided through the recovery flow path; and
a circulation flow path configured to guide the oil, from which the gas has been separated by the gas-liquid separator, to the supply pump.

10. The rotating electric machine system according to claim 9, further comprising a recovery pump configured to guide the oil stored in the reservoir to the gas-liquid separator.

11. The rotating electric machine system according to claim 10, further comprising a bypass flow path configured to return the oil flowing through the stator cooling flow path to the circulation flow path without passing the oil through the recovery pump and the gas-liquid separator.
